(19) United States
(12) Patent Application Publication
(10) Pub. No.: US 2026/0360289 A1
(43) Pub. Date: Nov. 12, 2026

(54) Scan driver with reduced control line

(71) Applicant: Hoseo University Academic Cooperation Foundation, Asan-si (KR)

(72) Inventors: Byung-Seong BAE, Suwon-si (KR); Hyuck-Su LEE, Incheon (KR); Seo-Jin KANG, Siheung-si (KR); Jang-Hoo LEE, Seongnam-si (KR); Seo-Yun KIM, Gunsan-si (KR)

(21) Appl. No.: 19/299,639

(22) Filed: Aug. 14, 2025

Related U.S. Application Data
(63) Continuation of application No. PCT/KR2023/002234, filed on Feb. 15, 2023.

(30) Foreign Application Priority Data
Feb. 15, 2023 (KR) 10-2023-0020386

(51) Int. Cl. G09G 3/20

(52) U.S. Cl. CPC G09G 3/20; G09G 2310/0267

(57) ABSTRACT

The present invention relates to a scan driving circuit with a reduced number of signal lines, and more particularly, to a scan driving circuit that is insensitive to variations in transistor characteristics so that stable operation can be achieved even when such variations occur within a certain range. Accordingly, the scan driving circuit has the advantage of providing high yield not only when applied to general rigid substrates but also when applied to flexible substrates or stretchable substrates. In addition, the invention relates to a scan driving circuit capable of minimizing an increase in the number of signal lines constituting the scan driving circuit even when the number of scans to be driven increases. According to the present invention, there is provided a scan driving circuit that reduces the number of required signal lines without reducing the number of scan outputs.

### BACKGROUND OF THE INVENTION

### 1. Field of the Invention

The present invention relates to a scan driving circuit with a reduced number of signal lines, and more specifically, to a scan driving circuit that is insensitive to variations in transistor characteristics so that stable operation can be achieved even when such variations occur within a certain range. Accordingly, the scan driving circuit has the advantage of providing a high yield not only when applied to general rigid substrates, but also when applied to flexible substrates Or stretchable substrates. In addition, the invention relates to a scan driving circuit capable of minimizing an increase in the number of signal lines constituting the scan driving circuit even when the number of scans to be driven increases.

### 2. Description of the Related Art

FIG. 1 is a block diagram an overall structure of a display and a scan driving circuit connected thereto.

Referring to FIG. 1, data applied to a pixel circuit of the display through a latch includes information on brightness, and the scan driving circuit performs a role of selecting a line on which such data is to be written.

Display technology has evolved from large and heavy cathode-ray tubes to thin and light liquid crystal display (LCD) technology, and televisions have also been manufactured using LCDs. As a subsequent technology after LCDs, organic light emitting diode (OLED) technology has been applied to televisions, and oxide transistors are being used. Oxide transistors have the advantage of higher mobility compared to amorphous silicon transistors, but they exhibit a characteristic in which the transfer curve shifts to the left, resulting in depletion-mode behavior where the transistor remains in the ON state even when the gate voltage is zero.

When a transistor exhibits depletion-mode characteristics, circuits designed for enhancement-mode operation do not function properly, and must be modified into circuits suitable for depletion mode. However, such circuits have the drawback of more complex configurations.

FIG. 2 shows an example of a conventional scan driving circuit (100), and FIG. 3 shows driving waveforms of the scan driving circuit (100) of FIG. 2.

In the conventional circuit, a first transistor T1 has both its gate electrode and drain electrode connected to a primary scan signal (PS), and thus operates like a diode. When a PS1 voltage (hereinafter, “V(PS1)”) increases in a positive direction and the difference from a voltage at point P (hereinafter, “V(P)”) becomes greater than or equal to a threshold voltage, that is, when “V(PS1)−V(P)≥threshold voltage,” the first transistor turns ON, allowing current to flow, and the voltage at point P increases and is set up. A capacitor C is connected to point P, and when an SS1 voltage connected to a second transistor T2 rises, the voltage is transferred to the source side of T2 and increases, whereby the voltage at point P rises due to capacitance. When the voltage at point P becomes greater than the PS1 voltage, the transistor should turn OFF so that no current flows, thereby maintaining the increased voltage, and the voltage applied to the gate electrode of the second transistor T2 increases, which increases the current flowing through the second transistor T2 to a scan line (Scan 1).

However, when the transistor exhibits depletion-mode characteristics, reverse current flows when the voltage at point P exceeds the PS1 voltage, preventing the voltage at point P from increasing. As a result, the gate voltage of the second transistor T2 does not increase, and the driving capability is not improved.

In addition, when the number of scans to be driven increases, the number of signal lines constituting the scan driving circuit also increases, which is problematic.

### SUMMARY OF THE INVENTION

The present invention has been devised to solve the above problems, and an object of the invention is to provide a scan driving circuit capable of reducing the number of required signal lines without reducing the number of scan outputs.

In order to achieve the above object, a scan driving circuit according to the present invention with a reduced number of signal lines comprises: a first thin film transistor (hereinafter, “first transistor”) configured to provide an input signal to a gate electrode of a second thin film transistor (hereinafter, “second transistor”) when in an ON state; the second transistor configured to output the input signal to an output scan signal line when in an ON state; a third thin film transistor (hereinafter, “third transistor”) configured to set a gate voltage of the second transistor into a source voltage of the third transistor when in an ON state; a fourth thin film transistor (hereinafter, “fourth transistor”) configured to set a scan output voltage of the output scan signal line into a voltage connected to a source of the fourth transistor when in an ON state; a capacitor for bootstrapping; a primary scan signal line for applying a signal to a gate electrode of the first transistor to control ON/OFF of the first transistor; a direct current (DC) power supply line connected to a drain electrode of the first transistor; a secondary scan signal line for applying, as an input signal to the second transistor, a signal to be output from the second transistor when the second transistor is in the ON state; a ground line connected to a source electrode of the fourth transistor; an output scan signal line for Outputting a final scan signal output from the second transistor; a fifth thin film transistor (hereinafter, “fifth transistor”) having a drain electrode and a gate electrode connected to the DC power supply line and a source electrode connected to the gate electrode of the third transistor; and a sixth thin film transistor (hereinafter, “sixth transistor”) having a drain electrode connected to the gate electrode of the third transistor and a gate electrode connected to the output scan signal line.

The DC voltage applied to the DC power supply line may be higher than a value obtained by subtracting a threshold voltage from a gate voltage of the first transistor.

The capacitor may have one electrode connected to a gate electrode of the second transistor and another electrode connected between output signal lines of the second transistor.

A source electrode of the third transistor may be connected to a first input signal line.

A source electrode of the third transistor may be connected to the output scan signal line.

The circuit may comprise t output scan signal lines, the t output scan signal lines being divided into a groups each having m output scan signal lines (hereinafter, “primary scan signal groups”) (a≥1); wherein a primary scan signal lines are provided,, each configured to turn ON/OFF the first transistor, the second transistor, the third transistor, and the fourth transistor of a different one of the a primary scan signal groups; wherein the m output scan signal lines of each group are connected, respectively, to one selected from among m secondary scan signal lines through one selected from among m second transistors; and wherein the m output scan signal lines of each group are further connected, respectively, to one selected from among m ground lines through one selected from among m fourth transistors. According to another aspect of the present invention, the scan driving circuit with a reduced number of signal lines comprises k circuit blocks (k≥2) having the configuration of the scan driving circuit, the k circuit blocks being connected in order as a first circuit block, a second circuit block, . . . , an i-th circuit block, an (i+1)-th circuit block, . . . , and a k-th circuit block, wherein the k-th circuit block outputs a final output scan signal, and where, when any two circuit blocks among the k circuit blocks that are adjacently connected are referred to as an i-th circuit block and an (i+1)-th circuit block (1≤i<k), a primary scan signal line of the (i+1)-th circuit block is configured as an extension of an output scan signal line of the i-th circuit block.

The i-th circuit block may comprise t output scan signal lines, the t output scan signal lines being divided into a groups each having m output scan signal lines (a≥1); wherein a primary scan signal lines of the i-th circuit block are provided, each configured to turn ON/OFF the first transistor, the second transistor, the third transistor, and the fourth transistor of a different one of the a primary scan signal groups; wherein the m output scan signal lines of each group are connected, respectively, to one selected from among m secondary scan signal lines through one selected from among m second transistors; and wherein the m output scan signal lines of each group are further connected, respectively, to one selected from among m ground lines through one selected from among m fourth transistors. The (i+1)-th circuit block may comprise m′ secondary scan signal lines, and for each of the t (=m×a) output scan signal lines of the i-th circuit block, a corresponding sub-circuit of the (i+1)-th circuit block in which an extension line of the output scan signal line serves as a primary scan signal line. The t sub-circuits of the (i+1)-th circuit block share the m′ secondary scan signal lines, and each sub-circuit of the (i+1)-th circuit block is provided with one primary scan signal line configured to turn ON/OFF the first transistor, the second transistor, the third transistor, and the fourth transistor of the sub-circuit. Each of the m′ secondary scan signal lines is connected to a respective one of m′ output scan signal lines, the m′ output scan signal lines being connected, respectively, to one selected from among the m′ secondary scan signal lines through one selected from among m′ second transistors, and further connected, respectively, to one selected from among the m′ ground lines through one selected from among m′ fourth transistors. The number of secondary scan signal lines may be independently set in each of the first circuit block through the k-th circuit block, and the number a of primary scan signal groups of the i-th circuit block (i≥2) may be equal to the number of output scan signal lines of the (i−1)-th circuit block.

The present invention provides an effect of scan driving circuit capable of reducing the number of required signal lines without reducing the number of scan outputs.

### BRIEF DESCRIPTION OF THE DRAWINGS

FIG. 1 is a block diagram illustrating an overall structure of a display and a scan driving circuit connected thereto.

FIG. 2 is a diagram showing an example of a conventional scan driving circuit.

FIG. 3 is a diagram illustrating driving waveforms of the scan driving circuit of FIG. 2.

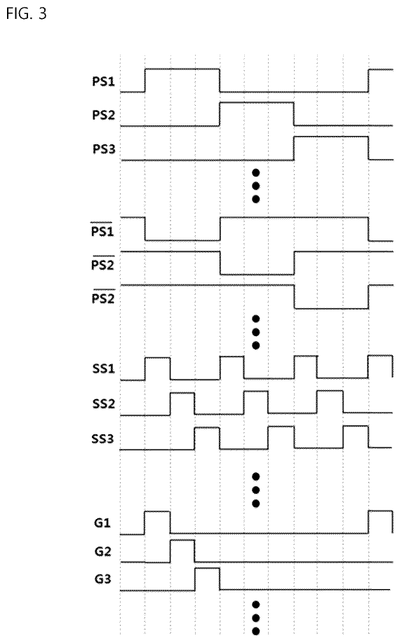

FIG. 4 is a diagram illustrating a scan driving circuit according to a first embodiment of the present invention.

FIG. 5 is a diagram illustrating a scan driving circuit according to a second embodiment of the present invention.

FIG. 6 is a diagram illustrating an example of a first circuit block or a second circuit block of a scan driving circuit with a reduced number of signal lines according to a third embodiment of the present invention.

FIG. 7 is a diagram illustrating another example of a first circuit block or a second circuit block of the scan driving circuit (500) with a reduced number of signal lines according to the third embodiment of the present invention.

FIG. 8 is a diagram illustrating a scan driving circuit with a reduced number of signal lines according to the third embodiment of the present invention.

### DETAILED DESCRIPTION OF THE INVENTION

Hereinafter, preferred embodiments of the present invention will be described in detail with reference to the accompanying drawings. Prior to this, terms and words used in the present specification and the claims shall not be interpreted as being limited to ordinary or dictionary meanings, but shall be construed in accordance with the meaning and concept consistent with the technical spirit of the present invention, based on the principle that the inventor can properly define the concepts of the terms in order to best describe his invention. Therefore, the embodiments described in the present specification and the configurations shown in the drawings are merely preferred embodiments of the present invention, and do not represent the entirety of the technical spirit of the invention, and thus it should be understood that various equivalents and modifications that can substitute for them at the time of filing may exist.

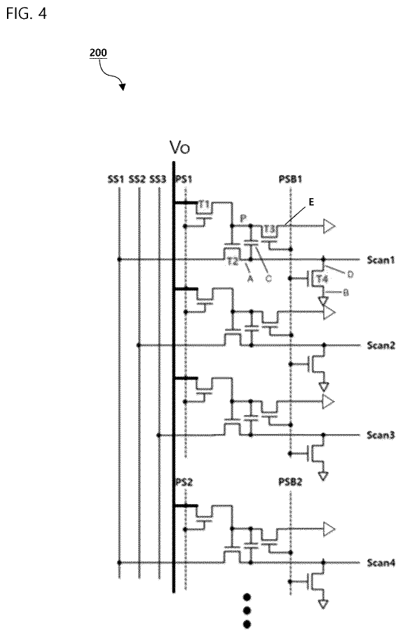

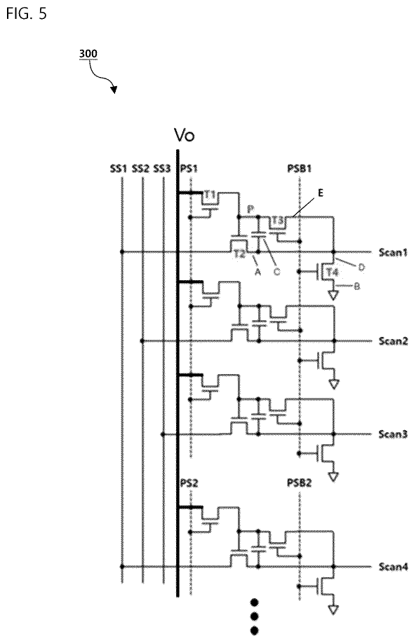

FIG. 4 is a diagram illustrating a scan driving circuit (200) according to a first embodiment of the present invention, and FIG. 5 is a diagram illustrating a scan driving circuit (200) according to a second embodiment of the present invention.

Referring to FIG. 4, the scan driving circuit (200) includes four switching thin film transistors (T1, T2, T3, T4), which will hereinafter be referred to as the first transistor, the second transistor, the third transistor, and the fourth transistor, respectively.

Each transistor may be implemented as an n-type MOSFET (Metal Oxide Semiconductor Field Effect Transistor), but is not limited thereto, and may also be implemented as a p-type MOSFET.

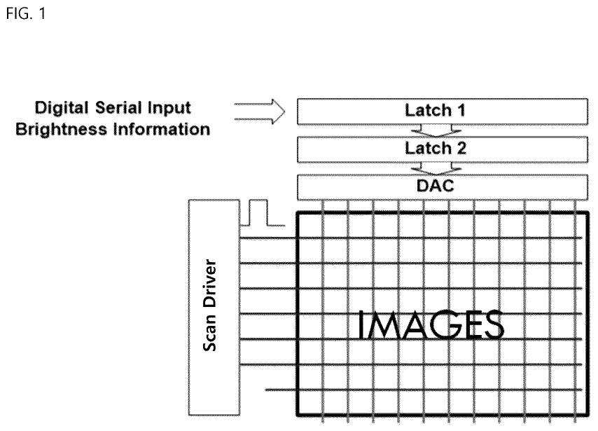

Generally, when the gate electrode and drain electrode of an enhancement-mode transistor are connected, it can operate like a diode and be utilized in a circuit. However, when the transistor exhibits depletion-mode characteristics, current flows in the reverse direction as well, so that it does not operate like a diode, and therefore the circuit of FIG. 1 does not operate normally.

To improve this, in the scan driving circuit (200) shown in FIG. 4, a primary scan signal (hereinafter, “PS1”) for controlling ON/OFF of the first transistor T1 is connected to the gate electrode of the first transistor T1 through the primary scan signal line, and the drain electrode of the first transistor T1 is connected to a separate DC power supply Vo. In this case, when the DC voltage Vo applied to the drain electrode of the first transistor T1 is made higher than a value obtained by subtracting a threshold voltage from the gate voltage, current does not flow through the first transistor T1 when the voltage at node P increases. For example, if the high voltage of the PS1 pulse is 5 V and the threshold voltage of the transistor is −1 V, Vo is applied to be higher than 5−(−1)=61 V. If the threshold voltage is 1 V, Vo is applied to be higher than 5−1=4 V.

The operation of the circuit in this case is as follows.

When a primary scan signal PS1 pulse is applied to the gate electrode of the first transistor T1, the first transistor T1 turns ON, and a voltage Vo connected to the drain electrode of the first transistor T1 causes the voltage at the source side to increase, thereby raising the voltage at node P. In this state, when a secondary scan signal SS1 pulse is applied, the SS1 pulse voltage is output through the second transistor T2, and the voltage at node A increases. At this time, due to the capacitor C, the voltage at node P is raised, thereby improving the current driving capability of the second transistor T2.

By the primary scan signal PS1, the first transistor T1 and the second transistor T2 are turned ON. For example, when the primary scan signal PS1 is at a “High” level, the first transistor T1 and the second transistor T2 are ON, and when the primary scan signal is at a “Low” level, the first transistor T1 and the second transistor T2 are in the OFF state.

When the second transistor T2 is in the ON state, a secondary scan signal (hereinafter, “SS1”) applied through the secondary scan signal line passes through the second transistor T2, and the value of the secondary scan signal SS1 is output as it is through an output signal line (hereinafter, “first output signal line”) (A) of the second transistor T2. The secondary scan signal SS1 is applied in the form of a pulse, and the duty ratio of the secondary scan signal SS1 has a value less than 1.

An inverter (not shown) converts the primary scan signal into “Low” when it is “High,” and into “High” when it is “Low.” The thus inverted signal (hereinafter, “primary scan inverted signal,” PSB1) is applied through a primary scan inverted signal line to the gate electrodes of the third transistor T3 and the fourth transistor T4 as ON/OFF control signals. That is, the primary scan signal (PS1) and the primary scan inverted signal (PSB1) are always in an inverted relationship.

When the fourth transistor T4 is in the ON state, the voltage of the scan signal line is changed to a voltage connected to the source electrode of the fourth transistor T4, which is denoted as point B. This voltage is adjusted according to the threshold voltage of the transistor and supplies a voltage capable of turning the transistor OFF. When the fourth transistor T4 is turned ON, the voltage at the source electrode B is supplied as a scan output voltage to the output scan signal line Scan1, and the voltage is applied to the gate electrodes of switching transistors in the pixel array connected to the output scan signal line Scan1, thereby turning the transistors into an OFF state. This voltage may be 0 volts or −10 volts, depending on the threshold voltage of the transistor.

The output scan signal line Scan1 is connected to a first output signal line A of the second transistor T2 and to an output signal line D (hereinafter, “second output signal line”) of the fourth thin film transistor.

When the primary scan signal is “High” (that is, when the primary scan inverted signal is “Low”), the first transistor T1 and the second transistor T2 are ON, and the third transistor T3 and the fourth transistor T4 are OFF, so that the secondary scan signal SS1 passes through the second transistor T2, is applied to the first output signal line A, and is output as a final signal through the output scan signal line Scan1. At this time, the voltage at node P is bootstrapped by the coupling effect of the capacitor C, thereby raising the gate voltage of the second transistor T2, which allows the first output signal to be output with less loss.

Similarly, when the primary scan signal is “Low” (that is, when the primary scan inverted signal is “High”), the first transistor T1 and the second transistor T2 are OFF, and the third transistor T3 and the fourth transistor T4 are ON, so that the voltage of the ground line B passes through the fourth thin film transistor and is output to the output scan signal line Scan1. The voltage of the ground line B is output to the output scan signal line Scan so that the output scan signal line Scan1 does not remain in a floating state during periods when a pulse is not supplied to the output scan signal line Scan1.

At this time, the third transistor T3 is turned ON, and the voltage at node P changes to the voltage of a first input signal line E, which is an input signal line of the third transistor T3, thereby turning the second transistor T2 OFF.

The scan driving circuit (300) of FIG. 5 is obtained from the circuit of FIG. 4 by connecting the source electrode of the third transistor T3 to the output scan signal line Scan1.

In FIG. 5, when the primary scan signal is “Low” (that is, when the primary scan inverted signal is “High”), the first transistor T1 and the second transistor T2 are OFF, and the third transistor T3 and the fourth transistor T4 are ON, so that the voltage of the ground line B passes through the fourth thin film transistor and is output to the output scan signal line Scan1, and the voltage of the ground line B is again transferred to the first input signal line E connected to the output scan signal line Scan1. The first input signal line E is connected to the source electrode of the third transistor T3.

When the voltage of the ground line B of the scan driving circuit (200) of FIG. 4 and the voltage of the first input signal line E connected to the source electrode of the third transistor T3 are the same, the above-described operation allows the scan driving circuit (300) of FIG. 5 to perform the same operation as the scan driving circuit (200) of FIG. 4.

In FIGS. 4 and 5, for convenience, the overall output signals are represented as two groups in which PS1 and PS2 are used as primary scan signals, respectively, but the number of groups may be set to an appropriate number as needed. Likewise, the secondary scan signals are illustrated as three signals SS1, SS2, and SS3 being input to each group, but the number of secondary scan signals may also be set to an appropriate number as needed.

This can be generally expressed as follows. That is, when the circuit comprises a total of t output scan signal lines, the t output scan signal lines are divided into a groups each having m output scan signal lines (hereinafter, “primary scan signal groups”) (a≥1). Accordingly, a pairs of primary scan signal lines and corresponding primary scan inverted signal lines are provided (PS1/PSB1, PS2/PSB2, PS3/PSB3, . . . , PSa/PSBa), and each pair turns ON/OFF the first transistor, the second transistor, the third transistor, and the fourth transistor of a selected one of the a primary scan signal groups.

The m output scan signal lines of each group are connected, respectively, to one selected from among m secondary scan signal lines (SS1, SS2, SS3, . . . , SSm) through one selected from among m second transistors T2.

In addition, the m output scan signal lines of each group are connected, respectively, to one selected from among m different ground lines B through one selected from among m different fourth thin film transistors.

At this time, all of the first transistors T1 of the group selected by the primary scan signal (PS) are turned ON, and the secondary scan signal (SS) applied to a second transistor T2 in that group is output. The fourth transistor T4 is selected by the primary scan inverted signal (PSB) to prevent the output scan signal line Scan from becoming floating after the output.

When using the scan driving circuit of the present invention as described above, even if the characteristics of thin film transistors and wiring resistance vary in general substrate materials or stretchable panels, signal loss in the output is small, and the circuit configuration prevents gate potentials from becoming floating. In addition, the circuit employs switching thin film transistors as circuit elements and uses a capacitor to perform the role of a scan driving circuit utilizing bootstrapping.

In particular, while a scan driving circuit of a general configuration does not operate when the transistor characteristics become depletion mode, the circuit having a separate DC power supply line (Vo), as shown in FIGS. 4 and 5, has the advantage of being operable in both depletion mode and enhancement mode.

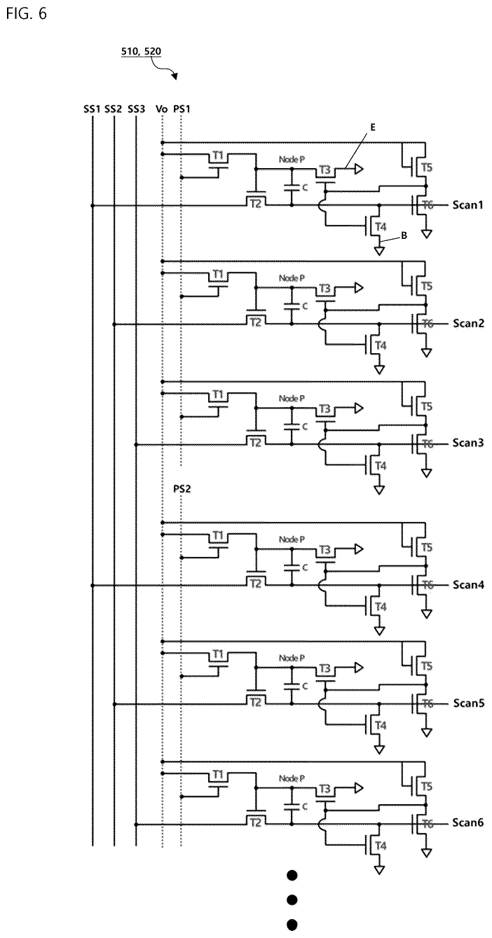

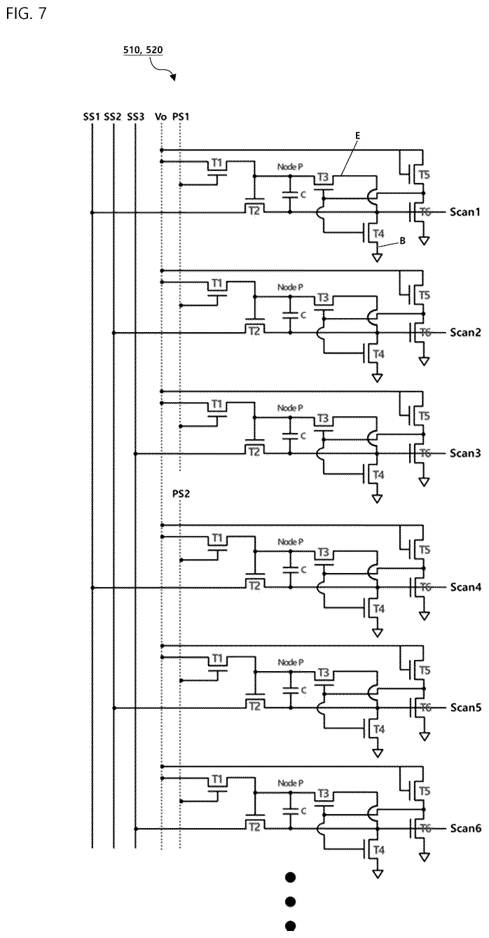

FIG. 6 is a diagram illustrating an example of a first circuit block (510) or a second circuit block (520) of a scan driving circuit (500) with a reduced number of signal lines according to a third embodiment of the present invention, and FIG. 7 is a diagram illustrating another example of a first circuit block (510) or a second circuit block (520) of the scan driving circuit (500) with a reduced number of signal lines according to the third embodiment of the present invention.

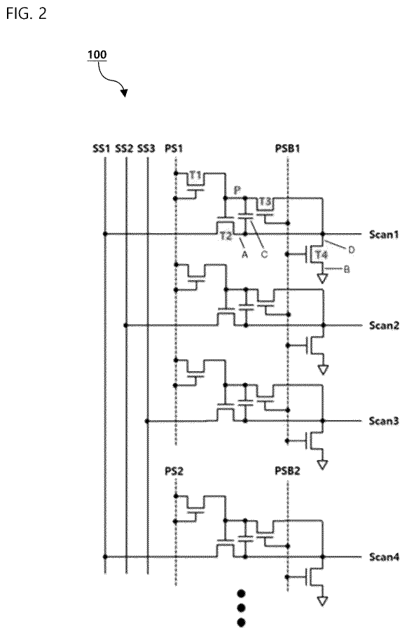

The difference between the circuits of FIGS. 6 and 7 and those of FIGS. 2, 4, and 5 is that in the circuits of FIGS. 6 and 7, the primary scan inverted signal line (PSB) does not exist. Thus, in each of the circuits of FIGS. 6 and 7, it is possible to reduce one primary scan inverted signal line per group of a groups.

That is, in the circuits of FIGS. 4 and 5, in order to obtain a×m output scan signals, m secondary scan signal lines and a pairs of primary scan signal lines and primary scan inverted signal lines were required, totaling 2a+m signal lines.

However, in the circuits of FIGS. 6 and 7, in order to obtain a×m output scan signals, only m secondary scan signal lines and one primary scan signal line per group of a groups are required without a primary scan inverted signal line, so that only a+m signal lines are needed, thereby reducing the number of signal lines.

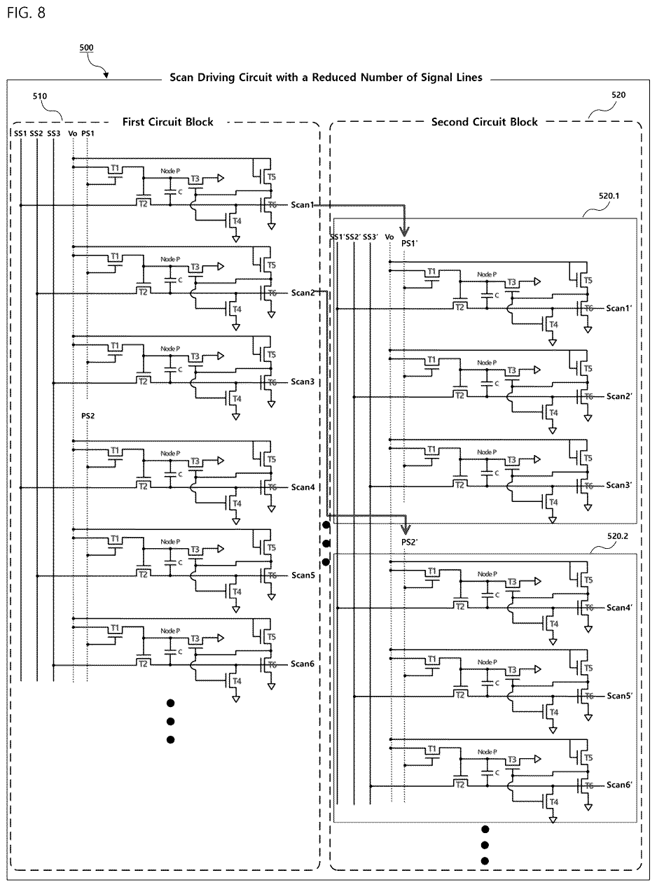

Furthermore, as shown in FIG. 8, when both the first circuit block (510) and the second circuit block (520) are configured with the circuits of FIG. 6 or FIG. 7, it is possible to achieve the effect of further significantly reducing the number of signal lines in the scan driving circuit, which is an advantage of the present invention.

In the circuits of FIGS. 2, 4, and 5, the primary scan inverted signal line (PSB) is connected to the gate electrode of the third transistor T3 and the gate electrode of the fourth transistor T4.

In the circuits of FIGS. 6 and 7, the primary scan inverted signal line (PSB) is eliminated, and in order to achieve the same effect as the primary scan inverted signal line (PSB), a fifth thin film transistor (hereinafter, “fifth transistor”) T5 and a sixth thin film transistor (hereinafter, “sixth transistor”) T6 are added.

Referring to FIGS. 6 and 7, the fifth transistor T5 has a drain electrode and a gate electrode connected to the DC power supply line (Vo), and a source electrode connected to the gate electrode of the third transistor T3.

The sixth transistor T6 has a drain electrode connected to the gate electrode of the third transistor T3, and a gate electrode connected to the output scan signal lines (Scan1, Scan2, . . . ).

By the connections of the fifth transistor T5 and the sixth transistor T6, the same effect as that of the primary scan inverted signal line (PSB) can be obtained without the primary scan inverted signal line (PSB), thereby achieving the effect of reducing the number of signal lines by eliminating the primary scan inverted signal line (PSB).

When the primary scan signal line PS becomes a turn-on voltage and a scan signal is output, the third transistor and the fourth transistor must be turned OFF in order to separate the output scan signal line from ground. Therefore, the output scan signal line is connected to the gate electrode of the sixth transistor, which is a driving transistor of an inverter, and the drain of the sixth transistor, which is the driving transistor of the inverter, is connected to the gate electrodes of the third transistor and the fourth transistor. In this way, when the scan output becomes high, a low voltage is applied to the gates of the third transistor and the fourth transistor, thereby turning the third transistor and the fourth transistor into the OFF state.

### This Effect Will Be Described in More Detail With

reference to FIG. 8.

The difference between the circuits of FIGS. 6 and 7 is the same as the difference between the circuits of FIGS. 4 and 5. In the circuit of FIG. 6, the source electrode of the third transistor T3 is connected to a first input signal line E, while in the circuit of FIG. 7, the source electrode of the third transistor T3 is connected to the output scan signal line (Scan1, Scan2, . . . ).

FIG. 8 is a diagram illustrating a scan driving circuit with a reduced number of signal lines according to a third embodiment of the present invention.

In order to minimize the number of signal lines for scan outputs, a driving circuit block (hereinafter, “second circuit block” 520) for reducing the number of signal lines is additionally connected to a scan driving circuit (hereinafter, “first circuit block” 510) corresponding to any one of FIGS. 6 and 7.

That is, as shown in FIG. 8, a driving circuit block (hereinafter, “second circuit block sub-circuit” 520.1 to 520.t) having m′ output scan signal lines is added to each output scan signal line (a×m lines) of the first circuit block (510). In each of the second circuit block sub-circuits (520.1 to 520.t) connected to the output scan signal lines (a×m lines) of the first circuit block (510), an extension line of the corresponding output scan signal line serves as a primary scan signal line of the second circuit block sub-circuit.

Accordingly, the output of the first circuit block (510) prepares to operate the second circuit block (520), and in the second circuit block (520), m′ signals are sequentially output by m′ secondary scan signals (SS1′, SS2′, SS3′, . . . ) supplied respectively to the T2 transistors. At this time, since each output scan signal line (a×m lines) of the first circuit block (510) has an additional m′ outputs of the second circuit block sub-circuits (520.1 to 520.t), the scan driving circuit (500) composed of the first circuit block (510) and the second circuit block (520) can generate a×m×m′ driving outputs, and the required number of signal lines is a+m+m′.

For example, when scan outputs are generated using only the first circuit block (510), the total number of required signal lines is a+m=10+81=91, based on m=81 secondary scan signal lines and a=10 primary scan signal lines, and the number of scan output signal lines is a×m=10×81=810.

However, in the scan driving circuit (500) of the present invention shown in FIG. 8, where the first circuit block (510) and the second circuit block (520) are combined, assuming m′=m=9 for convenience, the same number of scan output signal lines, a×m×m′=10×9×9=810, can be realized with only a=10, m=9, and m′=9 signal lines, and the total number of signal lines is a+m+m=10+9+9=28, which is significantly reduced compared to 91 signal lines in the case of implementing scan outputs with only the first circuit block (510).

For such a scan driving circuit (500), FIG. 8 illustrates an embodiment in which both the first circuit block (510) and the second circuit block (520) employ the scan driving circuit of FIG. 6.

However, the configuration of the first circuit block (510) or the second circuit block (520) may be applied separately with not only the circuit of FIG. 6 but also the circuit of FIG. 7. In addition, although FIG. 8 illustrates the connection of two circuits, more circuits having the configuration of FIG. 6 or FIG. 7 may be connected in the same manner as the connection between the first circuit block (510) and the second circuit block (520) so as to further reduce the number of signal lines.

What is claimed is:

1. A scan driving circuit with a reduced number of signal lines, comprising:
a first thin film transistor (hereinafter, “first transistor”) configured to provide an input signal to a gate electrode of a second thin film transistor (hereinafter, “second transistor”) when in an ON state;
the second transistor configured to output the input signal to an output scan signal line when in an ON state;
a third thin film transistor (hereinafter, “third transistor”) configured to set a gate voltage of the second transistor into a source voltage of the third transistor when in an ON state;
a fourth thin film transistor (hereinafter, “fourth transistor”) configured to set a scan output voltage of the output scan signal line into a voltage connected to a source of the fourth transistor when in an ON state;
a capacitor for bootstrapping;
a primary scan signal line for applying a signal to a gate electrode of the first transistor to control ON/OFF of the first transistor;
a direct current (DC) power supply line connected to a drain electrode of the first transistor;
a secondary scan signal line for applying, as an input signal to the second transistor, a signal to be output from the second transistor when the second transistor is in the ON state;
a ground line connected to a source electrode of the fourth transistor;
an output scan signal line for outputting a final scan signal output from the second transistor;
a fifth thin film transistor (hereinafter, “fifth transistor” ) having a drain electrode and a gate electrode connected to the DC power supply line and a source electrode connected to the gate electrode of the third transistor; and
a sixth thin film transistor (hereinafter, “sixth transistor”) having a drain electrode connected to the gate electrode of the third transistor and a gate electrode connected to the output scan signal line.

2. The scan driving circuit according to claim 1, wherein a direct current (DC) voltage applied to the DC power supply line is higher than a value obtained by subtracting a threshold voltage from a gate voltage of the first transistor.

3. The scan driving circuit according to claim 1, wherein the capacitor has one electrode connected to a gate electrode of the second transistor, and another electrode connected to an output signal line of the second transistor.

4. The scan driving circuit according to claim 1, wherein a source electrode of the third transistor is connected to a first input signal line.

5. The scan driving circuit according to claim 1, wherein a source electrode of the third transistor is connected to the output scan signal line.

6. The scan driving circuit according to claim 1, comprising t output scan signal lines, the t output scan signal lines being divided into a groups each having m output scan signal lines (hereinafter, “primary scan signal groups”) (a≥1) ;
wherein a primary scan signal lines are provided, each configured to turn ON/OFF the first transistor, the second transistor, the third transistor, and the fourth transistor of a different one of the a primary scan signal groups;
wherein the m output scan signal lines of each group are connected, respectively, to one selected from among m secondary scan signal lines through one selected from among m second transistors; and
wherein the m output scan signal lines of each group are further connected, respectively, to one selected from among m ground lines through one selected from among m fourth transistors.

7. A scan driving circuit with a reduced number of signal lines,
comprising k circuit blocks (k≥2) having the configuration of claim 1,
wherein the k circuit blocks are connected in order as a first circuit block, a second circuit block, . . . , an i-th circuit block, an (i+1)-th circuit block, . . . , and a k-th circuit block,
wherein the k-th circuit block outputs a final output scan signal, and
where, when any two circuit blocks among the k circuit blocks that are adjacently connected are referred to as an i-th circuit block and an (i+1)-th circuit block (1≤i<k),
a primary scan signal line of the (i+1)-th circuit block is configured as an extension of an output scan signal line of the i-th circuit block.

8. The scan driving circuit according to claim 7,
wherein the i-th circuit block comprises:
t output scan signal lines, the t output scan signal lines being divided into a groups each having m output scan signal lines (hereinafter, “primary scan signal groups”) (a≥1);
a primary scan signal line provided for each of the a primary scan signal groups, each configured to turn ON/OFF the first transistor, the second transistor, the third transistor, and the fourth transistor of a different one of the a primary scan signal groups;
wherein the m output scan signal lines of each group are connected, respectively, to one selected from among m secondary scan signal lines through one selected from among m second transistors;
wherein the m output scan signal lines of each group are further connected, respectively, to one selected from among m ground lines through one selected from among m fourth transistors;
wherein the (i+1)-th circuit block comprises:
m′ secondary scan signal lines; and
for each of the t (=m×a) output scan signal lines of the i-th circuit block, a corresponding sub-circuit of the (i+1)-th circuit block in which an extension line of the output scan signal line serves as a primary scan signal line;
wherein the t sub-circuits of the (i+1)-th circuit block share the m′ secondary scan signal lines, and each sub-circuit of the (i+1)-th circuit block is provided with one primary scan signal line configured to turn ON/OFF the first transistor, the second transistor, the third transistor, and the fourth transistor of the sub-circuit;
and wherein each of the m′ secondary scan signal lines is connected to a respective one of m′ output scan signal lines,
the m′ output scan signal lines being connected, respectively, to one selected from among the m′ secondary scan signal lines through one selected from among m′ second transistors,
and further connected, respectively, to one selected from among the m′ ground lines through one selected from among m′ fourth transistors;
wherein the number of secondary scan signal lines is independently set in each of the first circuit block through the k-th circuit block, and
wherein the number a of primary scan signal groups of the i-th circuit block (i≥2) is equal to the number of output scan signal lines of the (i−1)-th circuit block.
